(19) United States
(12) Patent Application Publication
(10) Pub. No.: US 2025/0153460 A1
(43) Pub. Date: May 15, 2025

(54) Gypsum Panel Having Enhanced Fire Resistance

(71) Applicant: Gold Bond Building Products, LLC, Charlotte, NC (US)

(72) Inventors: Xing Yang, Charlotte, NC (US); Ratnasabapathy Gurunathan Iyer, Charlotte, NC (US); Veda Evans, Charlotte, NC (US); Eli Stav, Charlotte, NC (US)

(21) Appl. No.: 18/941,197

(22) Filed: Nov. 8, 2024

Related U.S. Application Data
(60) Provisional application No. 63/597,878, filed on Nov. 10, 2023.

(51) Int. Cl. B32B 13/02; B32B 7/02; B32B 37/15; C04B 22/08; C04B 22/16; C04B 28/14; C04B 103/63; C04B 111/00; C04B 111/28

(52) U.S. Cl. CPC B32B 13/02; B32B 7/02; B32B 37/15; C04B 22/082; C04B 22/16; C04B 28/14; B32B 2250/40; B32B 2307/3065; B32B 2307/72; B32B 2318/00; B32B 2607/00; C04B 2103/63; C04B 2111/0062; C04B 2111/28

(57) ABSTRACT

The present invention is directed to a gypsum panel with enhanced fire resistance properties and a method of making such gypsum panel. In one embodiment, the gypsum panel comprises a gypsum core, a fire resistance composition, a first facing material, and a second facing material. The fire resistance composition may include phosphorus, nitrogen, boron, or a combination thereof. The weight ratio of phosphorus to nitrogen may be 40-95:0-50. The weight ratio of phosphorus to boron may be 40-95:0-10. The methods of the present invention are directed to making the aforementioned gypsum panels.

### RELATED APPLICATIONS

The present application is based upon and claims priority to U.S. Provisional Patent Application Ser. No. 63/597,878, having a filing date of Nov. 10, 2023, which is incorporated herein by reference in its entirety.

### BACKGROUND OF THE INVENTION

Gypsum panels are commonly employed in drywall construction of interior walls and ceilings and also have other applications. Generally, these gypsum panels are formed from a gypsum slurry including a mixture of calcined gypsum (i.e., stucco), water, and other conventional additives. The mixture is cast and allowed to set by reaction of the calcined gypsum with the water. During the production process, a variety of additives can be incorporated into the gypsum panel to enhance the physical and mechanical properties of the gypsum panel.

In general, various additives have been utilized to enhance the fire resistance properties of gypsum panels when the gypsum panels are exposed to high temperatures, such as those generated by a fire. Notably, the inclusion of various additives may reduce or prevent crack formation and/or fall-off. However, it remains to be ascertained which fire resistance compositions are particularly suitable for imparting certain fire resistance characteristics and properties, such as char formation, to gypsum panels.

As a result, a need exists for providing a gypsum panel with improved fire resistance properties. In particular, a need exists for providing a gypsum panel with enhanced fire resistance properties when exposed to high temperatures.

### SUMMARY OF THE INVENTION

Aspects and advantages of the invention will be set forth in part in the following description, or may be obvious from the description, or may be learned through practice of the invention.

In accordance with one embodiment of the present invention, a gypsum panel is disclosed. The gypsum panel comprises: a gypsum core, the gypsum core comprising gypsum; a fire resistance composition, the fire resistance composition comprising a phosphorus containing additive, the fire resistance composition comprising nitrogen, boron, or a combination thereof, wherein the weight ratio of phosphorus to nitrogen in the fire resistance composition is 40-95:0-50, wherein the weight ratio of phosphorus to boron in the fire resistance composition is 40-95:0-10; and a first facing material and a second facing material sandwiching the gypsum core.

In some aspects, the fire resistance composition may comprise nitrogen. In some aspects, the weight ratio of phosphorus to nitrogen in the fire resistance composition may be 45-75:20-50.

In general, the fire resistance composition may comprise boron. Notably, the weight ratio of phosphorus to boron in the fire resistance composition may be 45-75:1-10. In some aspects, the fire resistance composition may comprise nitrogen and boron. In general, the weight ratio of nitrogen to boron in the fire resistance composition may be 20-50:1-10.

In some aspects, the weight ratio of phosphorus, nitrogen, and boron in the fire resistance composition may be 40-95:1-50:1-10, such as 40-75:20-50:1-10.

Generally, the fire resistance composition may be present in the gypsum core in an amount from about 0.001 wt. % to about 3 wt. %. In some aspects, the fire resistance composition may be present in the gypsum panel in an amount from about 0.001 lbs/MSF to about 50 lbs/MSF.

Notably, the gypsum core may comprise a first gypsum core layer and a second gypsum core layer, the first gypsum core layer having a greater density than the second gypsum core layer, wherein the first gypsum core layer may comprise the fire resistance composition. The fire resistance composition may be present in the first gypsum core layer in an amount from about 0.001 wt. % to about 3 wt. %.

In some aspects, the fire resistance composition may be present on a surface of the first facing material, the second facing material, or both. Generally, the fire resistance composition may penetrate at least a portion of a thickness of the first facing material, the second facing material, or both.

In general, the fire resistance composition may applied to the first facing material, the second facing material, or both offline.

In some aspects, the fire resistance composition may comprise fiber.

In accordance with another embodiment of the present invention, a gypsum panel is disclosed. The gypsum panel comprises: a gypsum core, the gypsum core comprising gypsum; a fire resistance composition, the fire resistance composition comprising a phosphorus containing additive and a boron containing additive, wherein the weight ratio of phosphorus to boron in the fire resistance composition is 50-95:1-10; and a first facing material and a second facing material sandwiching the gypsum core.

Notably, the weight ratio of phosphorus to boron in the fire resistance composition may be 70-95:2-9. In general, the fire resistance composition may be present in the gypsum core in an amount from about 0.001 wt. % to about 10 wt. %.

In accordance with one embodiment of the present invention, a method of making a gypsum panel is disclosed. The method comprises: providing a first facing material; depositing a gypsum slurry comprising stucco and water onto the first facing material; providing a second facing material on the gypsum slurry; allowing the stucco to convert to calcium sulfate dihydrate; and wherein the gypsum panel comprises a fire resistance composition, the fire resistance composition comprising a phosphorus containing additive, the fire resistance composition comprising nitrogen, boron, or a combination thereof, wherein the weight ratio of phosphorus to nitrogen in the fire resistance composition is 40-95:0-50, wherein the weight ratio of phosphorus to boron in the fire resistance composition is 40-95:0-10.

### BRIEF DESCRIPTION OF THE DRAWINGS

A full and enabling disclosure of the present invention, directed to one of ordinary skill in the art, is set forth in the specification, which makes reference to the appended figures, in which:

FIG. 1 illustrates the facing material at the back of the gypsum panel sample of Example 1 after being subjected to a modified ASTM E119-16a heat ramp rate in a muffle furnace;

FIG. 2 illustrates the facing material at the back of the gypsum panel sample of Example 2 after being subjected to a modified ASTM E119-16a heat ramp rate in a muffle furnace;

FIG. 3 illustrates the facing material at the back of the gypsum panel sample of Example 3 after being subjected to a modified ASTM E119-16a heat ramp rate in a muffle furnace;

FIG. 4 illustrates the facing material at the back of the gypsum panel sample of Example 4 after being subjected to a modified ASTM E119-16a heat ramp rate in a muffle furnace; and

FIG. 5 illustrates the facing material at the back of the gypsum panel sample of Example 5 after being subjected to a modified ASTM E119-16a heat ramp rate in a muffle furnace.

Repeat use of reference characters in the present specification and drawings is intended to represent the same or analogous features or elements of the present invention.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum panel and a method of making such gypsum panel. In particular, the gypsum panel can include a gypsum core, one or more fire resistance compositions, and/or one or more facing materials. The present inventors have discovered that the gypsum panel disclosed herein can have various benefits due to the use of a fire resistance composition. For instance, the gypsum panel disclosed herein may have enhanced fire resistance properties and characteristics, such as enhanced char formation. Notably, enhanced char formation may result in a gypsum panel having improved thermal insulation properties, may provide for an improved barrier to oxygen, and/or may provide for an improved barrier to flames. Further, the gypsum panel of the present disclosure may have improved surface burning and improved thermal resistance.

Notably, a significant consideration when forming a fire resistant gypsum panel is the ability of the gypsum panel to form char and/or a char layer. In this respect, the formation of char and/or a char layer may be particularly advantageous for a fire resistance gypsum panel. Indeed, when exposed to high temperatures, the formation of char and/or a char layer may provide improved thermal insulation properties, may provide for an improved barrier to oxygen, and/or may provide for an improved barrier to flames.

It should be understood that throughout the entirety of this specification, each numerical value (e.g., weight percentage, concentration) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value. It should be understood that any concentration values disclosed herein may refer to mass concentration, molar concentration, number concentration, or volume concentration. It should be understood that, unless stated otherwise, any standard listed herein (e.g., ASTM) is the most recent version available as of the latest revision year. Notably, some aspects of the present disclosure may omit one or more of the features disclosed herein.

Notably, a gypsum panel formed in accordance with the present disclosure may possess enhanced shrinkage characteristics. The shrinkage of a gypsum panel may be measured via thermomechanical analyzer (TMA). The test may be conducted using the ASTM E119-16a ramp rates with a sample size of 5-10 mm by 5-10 mm by 0.5-26 mm including all increments of 1 mm therebetween. For instance, in one aspect, the test may be conducted using the ASTM E119-16a ramp rates with a sample size of 5 mm by 5 mm by 12.7 mm (12.7 mm thickness). For instance, in another aspect, the test may be conducted using the ASTM E119-16a ramp rates with a sample size of 5 mm by 5 mm by 15.875 mm (15.875 mm thickness). Using TMA, a change in dimension, in particular thickness can be determined and as measured herein, the shrinkage and thickness is based on the values at 950° C. Without the fire resistance composition as disclosed herein, a gypsum panel may have an average shrinkage of greater than 20%. However, by employing a fire resistance composition as disclosed herein, the gypsum panel may exhibit a shrinkage of 20% or less, such as 16% or less, such as 15% or less, such as 14% or less, such as 12% or less, such as 10% or less, such as 8% or less, such as 6% or less, such as 5% or less. The gypsum panel may have an average shrinkage of greater than 0%, such as 0.5% or more, such as 1% or more, such as 2% or more, such as 3% or more, such as 5% or more, such as 10% or more. Such percentages are based on the initial thickness.

As another means for determining the effect of the fire resistance composition on gypsum, the shrinkage can be measured by determining an area shrinkage (i.e., of a face instead of a thickness). For such area shrinkage, it can be determined utilizing a board sample or a cast gypsum bar, such as one having dimensions of 1″×1″×11.25″ (face or back of 1″×11.25″ and a thickness of 1″), drying the bar at 45° C. until a constant mass is obtained, and conditioning the bar at 70° F. and 50% RH for 12 hours. After conditioning, the bars or board samples are placed into a muffle furnace and quickly ramped according to ramp rates as defined in ASTM E119-16a to a temperature of about 950° C. The percentage change in shrinkage is determined by comparing the area after heating with the initial 1″×11.25″ or board sample area.

Notably, the utilization of a fire resistance composition in accordance with the present disclosure may result in a gypsum panel that has a Class 1 (i.e., Class A), Class 2 (i.e., Class B), or Class 3 (i.e., Class C) rating defined under ASTM E84. In this respect, a gypsum panel formed in accordance with the present disclosure may have enhanced surface burning characteristics.

Notably, the utilization of a fire resistance composition in accordance with the present disclosure may extend the time to failure as defined under ASTM E119-16a.

In some aspects, an assembly may be constructed using gypsum panels of the present disclosure wherein the assembly may conform to the specification of Underwriters Laboratories, Inc. (UL®) assemblies, such as U419, U305, and U423. For a fire test, the face of one side of the assembly can be exposed to increasing temperatures for a period of time in accordance with a heating curve, such as those discussed in ASTM E119-16a. The temperatures proximate the heated side and the temperatures at the surface of the unheated side of the assembly are monitored during the tests to evaluate the temperatures experienced by the exposed gypsum panels and the heat transmitted through the assembly to the unexposed panels.

In this regard, in one embodiment, an assembly of gypsum panels formed according to the present disclosure and in accordance with the specification of a U419 assembly, with or without cavity insulation, may have a fire rating of at least about 50 minutes, such as at least about 52.5 minutes, such as at least about 55 minutes, such as at least about 55.5 minutes, such as at least about 56 minutes, such as at least about 56.5 minutes, such as at least about 57 minutes, such as at least about 57.5 minutes, such as at least about 58 minutes, such as at least about 58.5 minutes, such as at least about 59 minutes, such as at least about 59.5 minutes, such as at least about 60 minutes, such as at least about 60.5 minutes, such as at least about 61 minutes, such as at least about 61.5 minutes, such as at least about 62 minutes, such as at least about 62.5 minutes, such as at least about 63 minutes, such as at least about 63.5 minutes, such as at least about 64 minutes, such as at least about 64.5 minutes, such as at least about 65 minutes when heated in accordance with the time-temperature curve of ASTM standard E119-16a. The fire rating may be 75 minutes or less, such as 73 minutes or less, such as 71 minutes or less, such as 70 minutes or less, such as 69 minutes or less, such as 68 minutes or less, such as 67 minutes or less, such as 66 minutes or less, such as 65 minutes or less, such as 64 minutes or less, such as 63 minutes or less, such as 62 minutes or less, such as 61 minutes or less.

In one embodiment, an assembly of gypsum panels formed according to the present disclosure and in accordance with the specification of a U305 assembly may have a fire rating of at least about 50 minutes, such as at least about 52.5 minutes, such as at least about 55 minutes, such as at least about 55.5 minutes, such as at least about 56 minutes, such as at least about 56.5 minutes, such as at least about 57 minutes, such as at least about 57.5 minutes, such as at least about 58 minutes, such as at least about 58.5 minutes, such as at least about 59 minutes, such as at least about 59.5 minutes, such as at least about 60 minutes, such as at least about 60.5 minutes, such as at least about 61 minutes, such as at least about 61.5 minutes, such as at least about 62 minutes, such as at least about 62.5 minutes, such as at least about 63 minutes, such as at least about 63.5 minutes, such as at least about 64 minutes, such as at least about 64.5 minutes, such as at least about 65 minutes when heated in accordance with the time-temperature curve of ASTM standard E119-16a. The fire rating may be 75 minutes or less, such as 73 minutes or less, such as 71 minutes or less, such as 70 minutes or less, such as 69 minutes or less, such as 68 minutes or less, such as 67 minutes or less, such as 66 minutes or less, such as 65 minutes or less, such as 64 minutes or less, such as 63 minutes or less, such as 62 minutes or less, such as 61 minutes or less.

In one embodiment, an assembly of gypsum panels formed according to the present disclosure and in accordance with the specification of a U423 assembly may have a fire rating of at least about 50 minutes, such as at least about 52.5 minutes, such as at least about 55 minutes, such as at least about 55.5 minutes, such as at least about 56 minutes, such as at least about 56.5 minutes, such as at least about 57 minutes, such as at least about 57.5 minutes, such as at least about 58 minutes, such as at least about 58.5 minutes, such as at least about 59 minutes, such as at least about 59.5 minutes, such as at least about 60 minutes, such as at least about 60.5 minutes, such as at least about 61 minutes, such as at least about 61.5 minutes, such as at least about 62 minutes, such as at least about 62.5 minutes, such as at least about 63 minutes, such as at least about 63.5 minutes, such as at least about 64 minutes, such as at least about 64.5 minutes, such as at least about 65 minutes when heated in accordance with the time-temperature curve of ASTM standard E119-16a. The fire rating may be 75 minutes or less, such as 73 minutes or less, such as 71 minutes or less, such as 70 minutes or less, such as 69 minutes or less, such as 68 minutes or less, such as 67 minutes or less, such as 66 minutes or less, such as 65 minutes or less, such as 64 minutes or less, such as 63 minutes or less, such as 62 minutes or less, such as 61 minutes or less.

In general, the gypsum core may comprise calcium sulfate dihydrate. The gypsum used to make the gypsum core may be from a natural source, a synthetic source, and/or reclaim and is thus not necessarily limited by the present invention. In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

In some aspects, the gypsum core may also comprise other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

Generally, a gypsum panel formed in accordance with the present disclosure may have a fire resistance composition applied (e.g., sprayed) to and/or incorporated in any component of the gypsum panel (e.g., a facing material, a gypsum slurry, a gypsum core, a gypsum core layer) at any time of the process disclosed herein, including during, before, and/or after any of the process steps disclosed herein. Notably, a fire resistance composition may be applied to and/or incorporated in one or more gypsum slurries (e.g., a first gypsum slurry, a second gypsum slurry, a third gypsum slurry) and/or one or more gypsum core layers (e.g., a first gypsum core layer, a second gypsum core layer, a third gypsum core layer). Generally, a fire resistance composition and/or any components thereof may be present between the first facing material and the gypsum slurry and/or gypsum core, and/or may be present between the second facing material and the gypsum slurry and/or gypsum core.

In some aspects, a fire resistance composition may be incorporated in and/or applied to one or more facing materials (e.g., first facing material, second facing material). Generally, the method of application of the fire resistance composition is not limited by the present disclosure and may include any method of application known in the art. Notably, the fire resistance composition may be incorporated in and/or applied to the first facing material, the gypsum slurry, the second facing material, or a combination thereof. In general, a fire resistance composition may be applied by spraying, brushing, curtain coating, and/or roll coating. In some aspects, a fire resistance composition may be incorporated in and/or applied to at least a portion of a surface of a first facing material and/or at least a portion of a surface of a second facing material that is adjacent to the gypsum slurry and/or gypsum core before the gypsum slurry is deposited, provided, or contacted with the first facing material and/or before the second facing material is provided on or contacted with the gypsum slurry respectively. Further, in some aspects, a fire resistance composition may be incorporated in and/or applied to the gypsum slurry before the second facing material is provided on or contacted with the gypsum slurry. In this respect, the fire resistance composition may be incorporated in and/or applied to at least a portion of the gypsum slurry adjacent the second facing material before the second facing material is provided on or contacted with the gypsum slurry. Additionally, in yet another aspect, the fire resistance composition may be incorporated in and/or applied to the gypsum slurry before the second facing material is provided on or contacted with the gypsum slurry and may be incorporated in and/or applied to at least a portion of the surface of the second facing material that is adjacent the gypsum slurry before the second facing material is provided on or contacted with the gypsum slurry.

Notably, the fire resistance composition may be applied to one or more facing materials (e.g., first facing material, second facing material) during the manufacturing process of the gypsum panel and/or in an offline process. When applied in an offline process, the fire resistance composition may be applied to a facing material (e.g., first facing material, second facing material) before the facing material is utilized in the manufacturing process of the gypsum panel.

In general, the fire resistance composition may be applied to one or more facing materials on a surface or side of a facing material (e.g., first facing material, second facing material) adjacent to a gypsum slurry and/or gypsum core. In general, the fire resistance composition may be applied to one or more facing materials on a surface or side of a facing material (e.g., first facing material, second facing material) opposite a gypsum slurry and/or gypsum core. In this respect, the fire resistance composition may be applied to one or more facing materials on the outward facing surface of one or more facing materials.

Notably, a fire resistance composition formed in accordance with the present disclosure may have a selectively chosen weight ratio of phosphorus, nitrogen, and boron. In this respect, the inventors of the present disclosure have discovered that the inclusion of fire resistance composition having a weight ratio of phosphorus, nitrogen, and boron of 40-95:0-50:0-10 in a gypsum panel may provide for enhanced char formation when the gypsum panel is subjected to high temperatures. Notably, when exposed to high temperatures, the particular weight ratio of phosphorus, nitrogen, and boron of 40-95:0-50:0-10 may produce decomposition products that result in a gypsum panel having enhanced fire resistance properties, such as enhanced char formation. Notably, in some aspects, the sum of two or more of the weight ratio values (e.g., three weight ratio values) may equal 100. In this respect, the sum of the phosphorus, nitrogen, and/or boron weight ratio values may be equal to 100. For instance, in one aspect, the weight ratio of phosphorus, nitrogen, and boron may be 50:40:10. For instance, in another aspect, the weight ratio of phosphorus, nitrogen, and boron may be 90:0:10.

In general, a fire resistance composition may contain phosphorus, nitrogen, and boron in a weight ratio of 40-95:0-50:0-10, including all incremental ratios therebetween. For instance, the phosphorus value of the weight ratio may be from about 40 to about 95, including all increments of 0.1 therebetween, such as about 40 or more, such as about 45 or more, such as about 50 or more, such as about 60 or more, such as about 70 or more, such as about 75 or more, such as about 80 or more, such as about 90 or more In general, the phosphorus value of the weight ratio may be about 95 or less, such as about 90 or less, such as about 80 or less, such as about 75 or less, such as about 70 or less, such as about 60 or less, such as about 50 or less, such as about 45 or less. The nitrogen value of the weight ratio may be from about 0 to about 50, including all increments of 0.1 therebetween, such as about 0 or more, such as about 10 or more, such as about 20 or more, such as about 30 or more, such as about 40 or more. In general, the nitrogen value of the weight ratio may be about 50 or less, such as about 40 or less, such as about 30 or less, such as about 20 or less, such as about 10 or less. The boron value of the weight ratio may be from about 0 to about 10, including all increments of 0.1 therebetween, such as about 0 or more, such as about 1 or more, such as about 2 or more, such as about 3 or more, such as about 4 or more, such as about 5 or more, such as about 6 or more, such as about 7 or more, such as about 8 or more, such as about 9 or more. In general, the boron value of the weight ratio may be about 10 or less, such as about 9 or less, such as about 8 or less, such as about 7 or less, such as about 6 or less, such as about 5 or less, such as about 4 or less, such as about 3 or less, such as about 2 or less, such as about 1 or less.

Notably, a gypsum panel formed in accordance with the present disclosure may include a fire resistance composition comprising one or more phosphorus containing additives, one or more nitrogen containing additives, and/or one or more boron containing additives. The one or more phosphorus containing additives, one or more nitrogen containing additives, and/or one or more boron containing additives may be selectively chosen to form a combination of additives that synergistically interact to enhance various fire resistant properties and characteristics of the gypsum panel. For instance, the one or more phosphorus containing additives may promote char formation and may inhibit gas phase chemical reactions. With respect to the char formation, when exposed to heat, the one or more phosphorus containing additives may form one or more acids that are involved in chemical reactions that result in char formation. Further, phosphorus containing additives may remove flammable OH— radicals with the formation of P—O bonds, which may slow down the exothermic radical process in the combustion zone. Additionally, for instance, the one or more nitrogen containing additives may inhibit gas phase chemical reactions. With respect to inhibiting gas phase chemical reactions, the one or more nitrogen containing additives may release nitrogen containing gases that dilute the oxygen concentration around and/or in the gypsum panel. Further, for instance, the one or more boron containing additives may promote char formation. In this respect, when exposed to heat, the one or more boron containing additives may decompose into boron containing gases that are involved in chemical reactions that result in char formation. Notably, one or more boron containing additives may form a carbonaceous char and/or a vitreous, insulation-like layer that strengthens and stabilizes the char.

Generally, the one or more phosphorus containing additives may include monoammonium phosphate, diammonium phosphate, sodium trimetaphosphate, ammonium polyphosphate, guanylurea phosphate, one or more metal salts of phosphoric acid, or a combination thereof. In some aspects, the one or more phosphorus containing additives may include an organic phosphate. In general, the one or more phosphorus containing additives may include an organophosphate. In some aspects, the one or more nitrogen containing additives may include monoammonium phosphate, diammonium phosphate, urea, melamine, dicyandiamide, ammonium salts or a combination thereof. Notably, in one aspect, the phosphorus containing additive and the nitrogen containing additive may be the same additive. Generally, the one or more boron containing additives may include boric acid, a metal borate (e.g., sodium borate), a metaborate, a borate salt, a boron oxide, or a combination thereof.

In some aspects, the fire resistance composition may include one or more fibers (e.g., natural fibers, ceramic fibers, mineral fibers). Notably, the fibers of a fire resistance composition may undergo pyrolysis when exposed to high temperatures. The pyrolysis of the fibers may result in carbonization and char formation.

In general, the one or more fibers may be present in a gypsum panel in an amount from about 0.001 wt. % to about 3 wt. % based on the weight of the stucco in the gypsum slurry, including all increments of 0.001 wt. % therebetween. For instance, the one or more fibers may be present in a gypsum panel in an amount of about 0.001 wt. % or more, such as about 0.01 wt. % or more, such as about 0.1 wt. % or more, such as about 0.5 wt. % or more, such as about 1 wt. % or more, such as about 1.5 wt. % or more, such as about 2 wt. % or more, such as about 3 wt. % or less, such as about 2 wt. % or less, such as about 1.5 wt. % or less, such as about 1 wt. % or less, such as about 0.5 wt. % or less, such as about 0.1 wt. % or less, such as about 0.01 wt. % or less based on the weight of the stucco in the gypsum slurry, which can be referred to as the amount of stucco used to form the gypsum slurry.

In general, the one or more fibers may be present in a fire resistance composition in an amount greater than about 0.01 wt. %, such as about 0.1 wt. % or more, such as about 0.5 wt. % or more, such as about 1 wt. % or more, such as about 1.5 wt. % or more, such as about 2 wt. % or more, such as about 3 wt. % or more, such as about 4 wt. % or more, such as about 5 wt. % or more, such as about 10 wt. % or more.

In one aspect, the fire resistance composition may include natural fiber. In one aspect, the natural fiber may include plant fiber. Notably, the plant fiber may include cork fiber, hemp fiber, cotton fiber, kenaf fiber, jute fiber, sisal fiber, ramie fiber, roselle fiber, flax fiber, sunn fiber, coir fiber, pina fiber, milkweed fiber, linen fiber, urena fiber, or a combination thereof.

In one aspect, the natural fiber may include cellulose fiber. The cellulose fiber may be derived from plant fiber such as wood fiber, cork fiber, hemp fiber, cotton fiber, kenaf fiber, jute fiber, sisal fiber, ramie fiber, roselle fiber, flax fiber, sunn fiber, coir fiber, pina fiber, milkweed fiber, linen fiber, urena fiber, or a combination thereof.

It should be understood that the fire resistance composition of the present disclosure may include one or more of the aforementioned fibers in any combination thereof. For instance, in one aspect, the fire resistance composition may include plant fiber, the plant fiber comprising plant fiber from more than one type of plant. Further, in another aspect, the fire resistance composition may include cellulose fiber, the cellulose fiber comprising cellulose fiber derived from more than one type of plant.

In some aspects, ceramic fibers and/or mineral fibers may be included in the fire resistance composition.

Generally, the fiber (e.g., plant fiber and/or cellulose fiber) may have an average fiber length of about 5 nanometers to about 7000 microns, including all increments of 1 nanometer therebetween. The average fiber length may be less than about 7000 microns, such as about 3000 microns or less, such as about 2000 microns or less, such as about 1000 microns or less, such as about 500 microns or less, such as about 400 microns or less, such as about 300 microns or less, such as about 200 microns or less, such as about 150 microns or less, such as about 100 microns or less, such as about 75 microns or less, such as about 50 microns or less, such as about 45 microns or less, such as about 40 microns or less, such as about 35 microns or less, such as about 30 microns or less, such as about 25 microns or less, such as about 20 microns or less, such as about 15 microns or less, such as about 10 microns or less, such as about 5 microns or less, such as about 1 micron or less, such as about 900 nanometers or less, such as about 800 nanometers or less, such as about 600 nanometers or less, such as about 500 nanometers or less, such as about 300 nanometers or less, such as about 200 nanometers or less, such as about 100 nanometers or less, such as about 50 nanometers or less, such as about 25 nanometers or less, such as about 10 nanometers or less, such as about 5 nanometers or more, such as about 10 nanometers or more, such as about 20 nanometers or more, such as about 30 nanometers or more, such as about 40 nanometers or more, such as about 50 nanometers or more, such as about 100 nanometers or more, such as about 250 nanometers or more, such as about 500 nanometers or more, such as about 750 nanometers or more, such as about 1 micron or more, such as about 5 microns or more, such as about 10 microns or more, such as about 15 microns or more, such as about 20 microns or more, such as about 25 microns or more, such as about 30 microns or more, such as about 35 microns or more, such as about 40 microns or more, such as about 45 microns or more, such as about 50 microns or more, such as about 75 microns or more, such as about 100 microns or more, such as about 200 microns or more, such as about 300 microns or more, such as about 400 microns or more, such as about 500 microns or more, such as about 1000 microns or more, such as about 2000 microns or more. Furthermore, in one aspect, the aforementioned values may refer to a median fiber length.

In general, a fire resistance composition may comprise a liquid. For instance, a fire resistance composition may comprise a liquid such as one or more surfactants, one or more dispersants, one or more siloxanes, one or more retarders, one or more alcohols, water, or a combination thereof. Additionally, in one aspect, the fire resistance composition may include an accelerator, such as one or more of the accelerators described in U.S. Pat. No. 9,878,950, which is incorporated herein by reference in its entirety.

Notably, in some aspects, the fire resistance composition, the gypsum core, a gypsum core layer, and/or the gypsum panel may be free or substantially free of perlite (e.g., expanded perlite), polyvinyl acetate polymer, polyvinyl alcohol, vermiculite, and/or expanded graphite. As used herein, “substantially free” means that the perlite, the polyvinyl acetate polymer, the polyvinyl alcohol, the vermiculite, and/or the expanded graphite content of the fire resistance composition, the gypsum core, the gypsum core layer, and/or the gypsum panel is less than about 0.01 wt. %.

Generally, a fire resistance composition and/or any components thereof may be in the form of a solid (e.g., powder, fines, granules), a liquid, or a mixture thereof. Notably, the components of the fire resistance composition may be combined by any method known in the art or disclosed herein. In general, a fire resistance composition may be incorporated in and/or applied to any component of a gypsum panel in the form of a solid, a liquid (e.g., a solution), or a mixture (e.g., a dispersion) thereof. As used herein, the term “dispersion” refers to a liquid having solid particles dispersed therein. In one aspect, the liquid of a dispersion may be water and the solid particles of the dispersion may be a phosphorus containing additive, a nitrogen containing additive, a boron containing additive, or a combination thereof. In general, the fire resistance composition may be applied and/or incorporated as a dry application, a wet application, or a combination thereof. As used herein, a “dry application” of a fire resistance composition refers to the application and/or incorporation of a fire resistance composition that does not comprise a liquid. As used herein, a “wet application” of a fire resistance composition refers to the application and/or incorporation of a fire resistance composition that comprises a liquid.

In some aspects, as previously disclosed herein, a surface of a facing material (e.g., first facing material, second facing material) adjacent to a gypsum slurry and/or gypsum core may include a fire resistance composition and/or any components thereof applied to and/or present on at least a portion of the surface of the facing material adjacent to the gypsum slurry and/or gypsum core. For instance, a fire resistance composition and/or any components thereof may be applied to and/or be present on the surface of a facing material adjacent to a gypsum slurry and/or gypsum core in an amount of about 1% or more of the surface area of the surface of the facing material, such as in an amount of about 1% or more, such as about 5% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less, such as about 5% or less of the surface area of the surface of the facing material.

As previously disclosed herein, a fire resistance composition may be applied to one or more facing materials. In general, a fire resistance composition may be applied to one or more plies of a facing material. In some aspects, the first facing material and/or the second facing material may include a top ply and a bottom ply. As used herein, the “top ply” refers to the ply of the facing material that is furthest from the gypsum slurry and/or gypsum core. As used herein, the “bottom ply” refers to the ply of the facing material that is closest to and/or adjacent to the gypsum slurry and/or gypsum core. In one aspect, the bottom ply may be penetrated by a fire resistance composition and/or any components thereof. It should be understood that if a facing material includes plies that are located between the top ply and the bottom ply, the bottom ply may be referred to as the first ply with the plies being numbered in ascending order. For instance, if a facing material consists of three plies, the bottom ply may be referred to as the first ply, the second ply may be referred to as the second ply, and the top ply may be referred to as the third ply.

In general, a facing material, such as a paper facing material, may include 1 to 8 plies. For instance, a facing material may include 1 ply or more, such as 2 plies or more, such as 3 plies or more, such as 4 plies or more, such as 5 plies or more, such as 6 plies or more, such as 7 plies or more, such as 8 plies or less, such as 7 plies or less, such as 6 plies or less, such as 5 plies or less, such as 4 plies or less, such as 3 plies or less, such as 2 plies or less. In one aspect, one or more plies of a facing material may comprise paper.

Notably, the application of a fire resistance composition may result in the penetration and/or embedment of a fire resistance composition and/or any components thereof in one or more of the facing materials (e.g., first facing material, second facing material). The application of a fire resistance composition may result in the penetration and/or embedment of the fire resistance composition and/or any components thereof in one or more plies of a facing material, such as the embedment or penetration of at least a portion of the thickness of the bottom ply of a facing material.

Generally, a fire resistance composition and/or any components thereof may penetrate at least a portion of the thickness of a respective facing material (e.g., first facing material, second facing material). In one aspect, the fire resistance composition and/or any components thereof may penetrate a respective facing material (e.g., first facing material, second facing material) by about 0% to about 100% of the thickness of the respective facing material, such as about 0% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less.

Generally, the fire resistance composition and/or any components thereof may penetrate one or more plies of a respective facing material (e.g., first facing material, second facing material). For instance, a fire resistance composition and/or any components thereof may penetrate one ply or more, such as 2 plies or more, such as 3 plies or more, such as 4 plies or more, such as 5 plies or more, such as 6 plies or more, such as 7 plies or more, such as 8 plies or less, such as 7 plies or less, such as 6 plies or less, such as 5 plies or less, such as 4 plies or less, such as 3 plies or less, such as 2 plies or less.

Generally, the longer the fire resistance composition and/or any components thereof is in contact with a facing material and/or one or more plies of a facing material, the deeper the penetration of the fire resistance composition and/or any components thereof. Notably, a fire resistance composition and/or any components thereof may be in contact with a facing material and/or one or more plies of a facing material for a period of about 1 second to about 30 seconds, including all increments of 1 second therebetween. For instance, a fire resistance composition and/or any components thereof may be in contact with a facing material and/or one or more plies of a facing material for about 1 second or more, such as about 5 seconds or more, such as about 10 seconds or more, such as about 15 seconds or more, such as about 20 seconds or more, such as about 25 seconds or more, such as about 30 seconds or less, such as about 25 seconds or less, such as about 20 seconds or less, such as about 15 seconds or less, such as about 10 seconds or less, such as about 5 seconds or less. In this respect, a fire resistance composition and/or any components thereof may be in contact with a facing material and/or one or more plies of a facing material for a period of about 1 second to about 30 seconds, including all increments of 1 second therebetween, until a gypsum slurry contacts or is provided on a respective facing material.

In general, a fire resistance composition may be present in and/or applied to the gypsum panel in an amount of 0.001 lbs/MSF to about 50 lbs/MSF, including all increments of 0.001 lbs/MSF therebetween. For instance, a fire resistance composition may be present in and/or applied to the gypsum panel in an amount of 0.001 lbs/MSF or more, such as 0.01 lbs/MSF or more, such as 0.05 lbs/MSF or more, such as 0.1 lb/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more, such as 40 lbs/MSF or more, such as 45 lbs/MSF or more. Generally, a fire resistance composition may be present in and/or applied to the gypsum panel in an amount of 50 lbs/MSF or less, such as 45 lbs/MSF or less, such as 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

Further, a fire resistance composition may be present in and/or applied to a gypsum panel and/or any component thereof in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 1.5 wt. % or more, such as 2 wt. % or more. Generally, a fire resistance composition may be present in and/or applied to a gypsum panel and/or any component thereof in an amount of 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.30 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

As previously disclosed, a fire resistance composition may comprise phosphorus. For instance, phosphorus may be present in a fire resistance composition in an amount from about 0.01 wt. % to about 100 wt. %, including all increments of 0.01 wt. % therebetween. In this respect, phosphorus may be present in a fire resistance composition in an amount of about 0.01 wt. % or more, such as about 1 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 60 wt. % or more, such as about 70 wt. % or more, such as about 80 wt. % or more, such as about 90 wt. % or more, such as about 100 wt. % or less, such as about 90 wt. % or less, such as about 80 wt. % or less, such as about 70 wt. % or less, such as about 60 wt. % or less, such as about 50 wt. % or less, such as about 45 wt. % or less, such as about 40 wt. % or less, such as about 35 wt. % or less, such as about 30 wt. % or less, such as about 25 wt. % or less, such as about 20 wt. % or less, such as about 15 wt. % or less, such as about 10 wt. % or less, such as about 5 wt. % or less, such as about 1 wt. % or less. It should be understood that the phosphorus may be a component of the phosphorus containing additive (e.g., diammonium phosphate).

As previously disclosed, a fire resistance composition may comprise nitrogen. For instance, nitrogen may be present in a fire resistance composition in an amount from about 0 wt. % to about 60 wt. %, including all increments of 0.01 wt. % therebetween. In this respect, nitrogen may be present in a fire resistance composition in an amount of about 0 wt. % or more, such as about 1 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 60 wt. % or less, such as about 50 wt. % or less, such as about 45 wt. % or less, such as about 40 wt. % or less, such as about 35 wt. % or less, such as about 30 wt. % or less, such as about 25 wt. % or less, such as about 20 wt. % or less, such as about 15 wt. % or less, such as about 10 wt. % or less, such as about 5 wt. % or less, such as about 1 wt. % or less. It should be understood that the nitrogen may be a component of the nitrogen containing additive (e.g., diammonium phosphate).

As previously disclosed, a fire resistance composition may comprise boron. For instance, boron may be present in a fire resistance composition in an amount from about 0 wt. % to about 20 wt. %, including all increments of 0.01 wt. % therebetween. In this respect, boron may be present in a fire resistance composition in an amount of about 0 wt. % or more, such as about 1 wt. % or more, such as about 2 wt. % or more, such as about 5 wt. % or more, such as about 8 wt. % or more, such as about 10 wt. % or more, such as about 15 wt. % or more, such as about 20 wt. % or less, such as about 15 wt. % or less, such as about 10 wt. % or less, such as about 8 wt. % or less, such as about 5 wt. % or less, such as about 2 wt. % or less, such as about 1 wt. % or less. It should be understood that the boron may be a component of the boron containing additive (e.g., boric acid).

As previously disclosed, a fire resistance composition may comprise a liquid (e.g., one or more surfactants, one or more dispersants, one or more siloxanes, one or more retarders, one or more alcohols, and/or water). For instance, a liquid may be present in a fire resistance composition in an amount from about 0 wt. % to about 99.99 wt. %, including all increments of 0.01 wt. % therebetween. In this respect, a liquid may be present in a fire resistance composition in an amount of about 0 wt. % or more, such as about 10 wt. % or more, such as about 20 wt. % or more, such as about 30 wt. % or more, such as about 40 wt. % or more, such as about 50 wt. % or more, such as about 55 wt. % or more, such as about 60 wt. % or more, such as about 65 wt. % or more, such as about 70 wt. % or more, such as about 75 wt. % or more, such as about 80 wt. % or more, such as about 85 wt. % or more, such as about 90 wt. % or more, such as about 95 wt. % or more, such as about 99.99 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less, such as about 50 wt. % or less, such as about 40 wt. % or less, such as about 30 wt. % or less, such as about 20 wt. % or less, such as about 10 wt. % or less.

In order to provide the desired effect, the fire resistance composition and/or any component thereof may have a selectively chosen average particle size. For instance, the fire resistance composition and/or any component thereof may have an average particle size of 5 mm or less, such as 4.5 mm or less, such as 4 mm or less, such as 3.5 mm or less, such as 3 mm or less, such as 2.5 mm or less, such as 2 mm or less, such as 1.5 mm or less, such as 1000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 150 microns or less, such as 100 microns or less, such as 75 microns or less, such as 50 microns or less, such as 40 microns or less, such as 25 microns or less, such as 20 microns or less, such as 15 microns or less, such as 10 microns or less, such as 5 microns or less, such as 1 micron or less, such as 900 nanometers or less, such as 800 nanometers or less, such as 600 nanometers or less, such as 500 nanometers or less, such as 300 nanometers or less, such as 200 nanometers or less, such as 100 nanometers or less, such as 50 nanometers or less, such as 25 nanometers or less, such as 10 nanometers or less. The fire resistance composition and/or any component thereof may have an average particle size of 1 nanometer or more, such as 5 nanometers or more, such as 10 nanometers or more, such as 20 nanometers or more, such as 30 nanometers or more, such as 40 nanometers or more, such as 50 nanometers or more, such as 100 nanometers or more, such as 250 nanometers or more, such as 500 nanometers or more, such as 750 nanometers or more, such as 1 micron or more, such as 5 microns or more, such as 10 microns or more, such as 20 microns or more, such as 25 microns or more, such as 40 microns or more, such as 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1000 microns or more, such as 1.5 mm or more, such as 2 mm or more, such as 2.5 mm or more, such as 3 mm or more, such as 3.5 mm or more, such as 4 mm or more, such as 4.5 mm or more. Furthermore, in one aspect, the aforementioned values may refer to a median particle size of the fire resistance composition and/or any components thereof. In this respect, the fire resistance composition and/or any components thereof may have a D₁₀, D₅₀, or D₉₀ of any of the values previously disclosed, including any incremental values therebetween.

Generally, the fire resistance composition and/or any components thereof may have a selectively chosen particle size distribution. The particle size distribution of the fire resistance composition and/or any components thereof may be monomodal, bi-modal, or multi-modal. The one or more modes may fall within any of the particle size values, including any ranges thereof, disclosed herein.

In general, the concentration of the fire resistance composition may be higher in the area of the gypsum core near a respective facing material and may decrease across a thickness of the gypsum core. In one aspect, any of the respective gypsum core layers (e.g., first gypsum core layer, second gypsum core layer, third gypsum core layer) may have a higher concentration of the fire resistance composition than the other gypsum core layers. In some aspects, one or more gypsum core layers may be free of the fire resistance composition.

Notably, the fire resistance composition may be heterogeneously or nonuniformly dispersed in a gypsum core of a gypsum panel. In one aspect, the concentration of the fire resistance composition may be such that a concentration gradient of the fire resistance composition is formed in a gypsum core of a gypsum panel. In some aspects, the concentration gradient may be such that the concentration of the fire resistance composition increases or decreases over a portion of the thickness, such as a thickness disclosed herein, of a gypsum core of a gypsum panel. In one aspect, a gypsum core of a gypsum panel may have a higher concentration of the fire resistance composition in the portion of a gypsum core adjacent to the first facing material (e.g., the first gypsum core layer) with the concentration of the fire resistance composition decreasing across a dimension (e.g., the thickness) of the gypsum core. In general, in one aspect, the concentration of the fire resistance composition in a gypsum core of a gypsum panel may decrease across a thickness of a gypsum core beginning at the portion of a gypsum core adjacent the first facing material and ending at the portion of the gypsum core adjacent the second facing material or ending at the center of the thickness of the gypsum core. It should be understood that the center of the thickness of a gypsum core of a gypsum panel is parallel to one or more respective facing materials and may be a plane that extends the length and width of a gypsum core.

In one aspect, a gypsum core of a gypsum panel may have a higher concentration of the fire resistance composition in the portion of the gypsum core adjacent to the second facing material (e.g., the third gypsum core layer) with the concentration of the fire resistance composition decreasing across a dimension (e.g., the thickness) of the gypsum core. In general, in one aspect, the concentration of a fire resistance composition in a gypsum core of a gypsum panel may decrease across the thickness of the gypsum core beginning at the portion of the gypsum core adjacent the second facing material and ending at the portion of the gypsum core adjacent the first facing material.

In one aspect, a gypsum core of a gypsum panel may have a higher concentration of the fire resistance composition in the portion of the gypsum core adjacent to the first facing material as compared to the concentration of the fire resistance composition in the portion of the gypsum core adjacent to the second facing material. In this respect, the concentration of the fire resistance composition in the portion of a gypsum core of a gypsum panel adjacent to the first facing material may be higher than the concentration of the fire resistance composition in the portion of the gypsum core adjacent to the second facing material. In another aspect, a gypsum core of a gypsum panel may have a higher concentration of the fire resistance composition in the portion of the gypsum core adjacent to the second facing material as compared to the concentration of the fire resistance composition in the portion of the gypsum core adjacent to the first facing material. In this respect, the concentration of the fire resistance composition in the portion of the gypsum core of the gypsum panel adjacent to the second facing material may be higher than the concentration of the fire resistance composition in the portion of the gypsum core adjacent to the first facing material.

In yet another aspect, the concentration of the fire resistance composition in a gypsum core of the gypsum panel may be higher in the portions of the gypsum core adjacent to the respective facing materials. For instance, the concentration of the fire resistance composition in a gypsum core of a gypsum panel may be higher in the portions of the gypsum core adjacent the first facing material and the second facing material, as compared to the center of the thickness of the gypsum core. In one aspect, a gypsum core of the gypsum panel may have a higher concentration of the fire resistance composition adjacent to the first facing material and the second facing material with the concentration of the fire resistance composition decreasing toward the center of the thickness of the gypsum core beginning at the portions of the gypsum core adjacent the first facing material and second facing material respectively.

Notably, in one aspect, the three highest concentrations of the fire resistance composition in a gypsum core of a gypsum panel may be at the portion of the gypsum core adjacent the first facing material, at the center of the thickness of the gypsum core, and at the portion of the gypsum core adjacent the second facing material respectively. In this respect, the area of a gypsum core of a gypsum panel between the portion of the gypsum core adjacent the first facing material and the center of the thickness of the gypsum core may have a reduced concentration of the fire resistance composition compared to the concentration of the fire resistance composition in the portion of the gypsum core adjacent the first facing material and the center of the thickness of the gypsum core. Further, the area of a gypsum core of a gypsum panel between the portion of the gypsum core adjacent the second facing material and the center of the thickness of the gypsum core may have a reduced concentration of the fire resistance composition compared to the concentration of the fire resistance composition in the portion of the gypsum core adjacent the second facing material and the center of the thickness of the gypsum core.

Notably, it should be understood that a portion of a gypsum core of a gypsum panel (e.g., a portion of a gypsum core adjacent to a facing material) may refer to a portion of a thickness of a gypsum core, such as 1/16 inches or more, such as 1/12 inches or more, such as ⅛ inches or more, such as ¼ inches or more. In this respect, in some aspects, a portion of a gypsum core adjacent to a facing material may be 1/12 inches or more, such as ⅛ inches or more, such as ¼ inches or more. It should be understood that a portion of a gypsum core of a gypsum panel (e.g., a portion of a gypsum core adjacent to a facing material) may refer to a portion of a thickness of a gypsum core, such as ½ inches or less, such as ¼ inches or less, such as ⅛ inches or less, such as 1/12 inches or less. In this respect, in some aspects, a portion of a gypsum core adjacent to a facing material may be ½ inches or less, such as ¼ inches or less, such as ⅛ inches or less, such as 1/12 inches or less.

Notably, the portion of a gypsum core adjacent to a facing material parallel may be parallel to one or more respective facing materials and may be a plane that extends the length and width of a gypsum core.

Further, it should be understood that the portion of a gypsum core of a gypsum panel adjacent to the first facing material may be referred to as the first gypsum core layer. Additionally, when a gypsum core of a gypsum panel includes two gypsum core layers, the portion of the gypsum core adjacent to the second facing material may be referred to as the second gypsum core layer. Further, when a gypsum core of a gypsum panel includes three gypsum core layers, the portion of the gypsum core adjacent to the second facing material may be referred to as the third gypsum core layer.

In one aspect, the ratio of the concentration of the fire resistance composition at the interface of a gypsum core of a gypsum panel and a facing material (e.g., the first facing material, the second facing material) to the concentration of the fire resistance composition at the center of the thickness of the gypsum core may be from about 20:1 to about 1:20, including all incremental ratios therebetween. Generally, the ratio of the concentration of the fire resistance composition at the interface of the gypsum core and a facing material (e.g., the first facing material, the second facing material) to the concentration of the fire resistance composition at the center of the thickness of the gypsum core may be about 20:1 or less, such as about 15:1 or less, such as about 10:1 or less, such as about 5:1 or less, such as about 1:1 or less, such as about 1:5 or less, such as about 1:10 or less, such as about 1:15 or less. In general, the ratio of the concentration of the fire resistance composition at the interface of the gypsum core and a facing material (e.g., the first facing material, the second facing material) to the concentration of the fire resistance composition at the center of the thickness of the gypsum core may be about 1:20 or more, such as about 1:15 or more, such as about 1:10 or more, such as about 1:5 or more, such as about 1:1 or more, such as about 5:1 or more, such as about 10:1 or more, such as about 15:1 or more.

In general, the composition of the gypsum core is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

In some aspects, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, a gypsum panel formed in accordance with the present disclosure may be formed from a method as disclosed herein. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

In general, the composition of the gypsum slurry is not necessarily limited and may be any generally known in the art. Generally, in one embodiment, the gypsum core is made from a gypsum slurry including at least stucco and water.

In general, stucco may be referred to as calcined gypsum or calcium sulfate hemihydrate. The calcined gypsum may be from a natural source, a synthetic source, or reclaim and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be anhydrite (e.g., AII, AIII), α-hemihydrate, β-hemihydrate, or a mixture thereof.

In addition to the stucco, the gypsum slurry may also contain other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

As indicated above, the gypsum slurry may include water. Water may be employed for fluidity and also for rehydration of the gypsum to allow for setting.

The weight ratio of the water to the stucco may be 0.1 or more, such as 0.2 or more, such as 0.2 or more, such as 0.3 or more, such as 0.4 or more, such as 0.5 or more, such as 0.6 or more, such as 0.7 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

In one aspect, the foaming agent may include one or more foam stabilizers, such as ethoxylated glycerine. The one or more foam stabilizers may be present in the gypsum slurry and/or gypsum core in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less by weight of the foaming agent. The one or more foam stabilizers may be present in the gypsum slurry and/or gypsum core in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more by weight of the foaming agent.

By utilizing a soap, foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

In some aspects, the gypsum slurry, gypsum core, and/or fire resistance composition may include a dispersant, such as a carboxylate or a sulfonate. The dispersant is not necessarily limited and may include any that can be utilized within the gypsum slurry. The dispersant may include carboxylates, sulfates, sulfonates, phosphates, mixtures thereof, etc.

In one embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate. In one embodiment, the phosphate may be sodium monofluorophosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

In some aspects, the additives of the gypsum slurry, gypsum core, and/or a fire resistance composition may include one or more surfactants. In general, the surfactant may be an anionic surfactant, a cationic surfactant, a non-ionic surfactant, a fluorinated surfactant, a silicon surfactant, or a mixture thereof. Generally, a surfactant may be in the form of a solid, a liquid, or a combination thereof.

As indicated above, in one embodiment, the surfactant may include an anionic surfactant. In general, anionic surfactants include those having one or more negatively charged functional groups. For instance, the anionic surfactant may include an alkali metal or ammonium salts of alkyl, aryl or alkylaryl sulfonates, sulfates, or a mixture thereof. In some aspects, the anionic surfactant may include ammonium lauryl sulfate, sodium lauryl sulfate, sodium octylphenol glycolether sulfate, sodium laureth sulfate, sodium myreth sulfate, sodium dodecylbenzene sulfonate, perfluorobutane sulfonate, dodecyl benzene sulfonate, alpha-olefin sulfonate, sodium lauryldiglycol sulfate, ammonium tritertiarybutyl phenol and penta- and octa-glycol sulfonates, sulfosuccinate salts such as disodium ethoxylated nonylphenol half ester of sulfosuccinic acid, disodium n-octyldecyl sulfosuccinate, sodium dioctyl sulfosuccinate, alpha olefin sulfonate, and mixtures thereof. Other examples include a C₈-C₂₂ alkyl fatty acid salt of an alkali metal, alkaline earth metal, ammonium, alkyl substituted ammonium, for example, isopropylamine salt, or alkanolammonium salt, a C₈-C₂₂ alkyl fatty acid ester, a C₈-C₂₂ alkyl fatty acid ester salt, and alkyl ether carboxylates. Further, the anionic surfactant may include a phosphate (alkyl-aryl ether phosphates, alkyl ether phosphates, etc.), a phosphite, a phosphonate, a carboxylate (e.g., sodium stearate, etc.), or a mixture thereof.

In one particular embodiment, the anionic surfactant may include a water-soluble salt, particularly an alkali metal salt, of an organic sulfur reaction product having in their molecular structure an alkyl radical containing from about 8 to 22 carbon atoms and a radical selected from the group consisting of sulfonic and sulfuric acid ester radicals. Organic sulfur based anionic surfactants include the salts of C₁₀-C₁₆ alkylbenzene sulfonates, C₁₀-C₂₂ alkane sulfonates, C₁₀-C₂₂ alkyl ether sulfates, C₁₀-C₂₂ alkyl sulfates, C₄-C₁₀ dialkylsulfosuccinates, C₁₀-C₂₂ acyl isothionates, alkyl diphenyloxide sulfonates, alkyl naphthalene sulfonates, C₁₀-C₂₀ alpha olefin sulfonates, and 2-acetamido hexadecane sulfonates. In one aspect, the anionic surfactant may include C₆-C₁₂ linear and/or branched alkyl sulfates and/or C₆-C₁₂ linear and/or branched alkyl ether sulfates. Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Particular examples of anionic surfactants include a polyoxyethylene alkyl ether sulfuric ester salt, a polyoxyethylene alkylphenyl ether sulfuric ester salt, polyoxyethylene styrenated alkylether ammonium sulfate, polyoxymethylene alkylphenyl ether ammonium sulfate, and the like, and mixtures thereof. For instance, the anionic surfactant may include a polyoxyethylene alkyl ether sulfuric ester salt, a polyoxyethylene alkylphenyl ether sulfuric ester salt, or a mixture thereof. In some aspects, the anionic surfactant may include sulfated alkanolamide, glyceride sulfate, or a mixture thereof.

As indicated above, in one embodiment, the surfactant may include a non-ionic surfactant. In one aspect, the nonionic surfactant may be an amine oxide. In one aspect, the nonionic surfactant may be an ethoxylate. For instance, the nonionic surfactant may be an ethoxylated fatty alcohol, a linear alcohol ethoxylate (e.g., narrow-range ethoxylate, octaethylene glycol monododecyl ether, pentaethylene glycol monododecyl ether, etc.), an alkylphenol ethoxylate (e.g., a nonoxynol, octylphenol ethoxylate, etc.), a fatty acid ethoxylate, an ethoxylated fatty ester, or an ethoxylated amine. In some aspects, the nonionic surfactant may be and/or include fatty acid amides (e.g., polyethoxylated tallow amine, cocamide monoethanolamine, cocamide diethanolamine, etc.), fatty acid esters of glycerol (e.g., glycerol monostearate, glycerol monolaurate, etc.), fatty acid esters of sorbitol (e.g., sorbitan monolaurate, sorbitan monostearate, sorbitan tristearate, etc.), alkyl polyglycosides (e.g., decyl glucoside, lauryl glucoside, octyl glucoside, etc.), block copolymers of polyethylene glycol and polypropylene glycol, glycerol alkyl esters, alkyl polyglucosides, polyoxyethylene glycol octylphenol ethers, sorbitan alkyl esters, polyoxyethylene glycol sorbitan alkyl esters, and mixtures thereof. For instance, the non-ionic surfactant may include a polyethylene oxide condensate of an alkyl phenol (e.g., the condensation product of an alkyl phenol having an alkyl group containing from 6 to 12 carbon atoms in either a straight chain or branched chain configuration, with ethylene oxide (e.g., present in amounts equal to 1 to 40 moles)). The alkyl substituent may be derived, for example, from polymerized propylene, di-isobutylene, octane or nonene. Other examples include dodecylphenol condensed with 12 moles of ethylene oxide per mole of phenol; dinonylphenol condensed with 5 moles of ethylene oxide per mole of phenol; nonylphenol condensed with 9 moles of ethylene oxide per mole of nonylphenol and di-iso-octylphenol condensed with 5 moles of ethylene oxide. The non-ionic surfactant may be a condensation product of a primary or secondary aliphatic alcohol having from 8 to 24 carbon atoms, in either straight chain or branched chain configuration, with from 1 to about 40 moles of alkylene oxide per mole of alcohol. The non-ionic surfactant may include a compound formed by condensing ethylene oxide with a hydrophobic base formed by the condensation of propylene oxide with propylene glycol (e.g., Pluronics). In one embodiment, the surfactant may be a silicon surfactant such as a polyether-modified siloxane.

In one embodiment, the surfactant may include a cationic surfactant. For instance, the surfactant may include a cationic surfactant such as water-soluble quaternary ammonium compounds, polyammonium salts, a polyoxyethylene alkylamine and the like. In some aspects, the surfactant may include a cationic surfactant such as a quaternary ammonium salt (e.g., cetrimonium bromide, cetylpyridinium chloride, benzalkonium chloride, benzethonium chloride, dimethyldioctadecylammonium chloride, and dioctadecyldimethylammonium bromide, etc.).

Notably, the gypsum slurry, gypsum core, and/or fire resistance composition may include a starch. The starch may be one generally utilized in the art. Such starch may be combined with the stucco and water. In this regard, such starch may be present in the gypsum slurry as well as the resulting gypsum core and gypsum panel. In one aspect, one or more components of a gypsum panel may be free of starch. For instance, the gypsum core and/or gypsum slurry may be free of starch. In one aspect, a gypsum panel formed in accordance with the present disclosure may be free of starch.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example, in one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorus acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorus acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more. The gelling temperature may be 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively lower gelling temperature. Meanwhile, without intending to be limited by theory, modifications of the hydroxyl group, such as by replacement via ethoxylation, ethylation, oxidation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present invention.

In one aspect, the starch may be provided in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

The manner in which the components (e.g., stucco, water, fire resistance composition) for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the components are incorporated into the gypsum slurry is not necessarily limited by the present invention. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soap may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, the calcium sulfate hemihydrate reacts with the water to hydrate the calcium sulfate hemihydrate into a crystalline matrix of calcium sulfate dihydrate. In this respect, the stucco may convert into calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for drying of the gypsum slurry, in particular drying any free water instead of combined water of the gypsum slurry. Such drying may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device to undergo a drying process. For instance, such a heating or drying device may be a kiln and may allow for removal of any free water. The temperature and time required for drying in a heating device is not necessarily limited by the present invention.

In one embodiment, the gypsum core may include a first gypsum core layer and a second gypsum core layer. The first gypsum core layer may be between the first facing material (e.g., front of the gypsum panel) and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material (e.g., back of the gypsum panel). Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

The gypsum panel disclosed herein may have many applications. For instance, the gypsum panel may be used as a standalone panel in construction for the preparation of walls, ceilings, floors, roofing, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

In one embodiment, the gypsum panel may be processed such that any respective gypsum core layer may have an average void size of about 50 microns to about 1200 microns, such as about 50 microns or more, such as about 100 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more, such as about 600 microns or more, such as about 700 microns or more, such as about 800 microns or more. Generally, the average void size may be about 1200 microns or less, such as about 1100 microns or less, such as about 1000 microns or less, such as about 900 microns or less, such as about 800 microns or less, such as about 700 microns or less, such as about 600 microns or less, such as about 500 microns or less, such as about 400 microns or less, such as about 300 microns or less, such as about 200 microns or less, such as about 100 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 15 m²/g, including all increments of 0.01 m²/g therebetween. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present invention is not necessarily limited by the aforementioned thicknesses.

In addition, the panel weight of the gypsum panel is not necessarily limited. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 Ibf as tested according to ASTM C1396-17. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396-17. The gypsum panel may have a core hardness of 50 lb or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396-17 and ASTM C473-19. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17 and ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, as previously disclosed, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%+3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

### EXAMPLES

Gypsum panels were made in accordance with the descriptions below. The gypsum panels were analyzed to determine the fire resistance of the respective gypsum panels. For testing, a 12″×12″ sample of each gypsum panel was mounted onto a muffle furnace wall and subjected to a modified ASTM E119-16a heat ramp rate. In this respect, the samples are placed into a muffle furnace and ramped using the following modified ASTM E119-16a heat ramp rate: at 5 mins=165° C.; at 10 mins=330° C.; at 30 mins=843° C.; at 60 mins=927° C. All of the Examples (i.e., Example 1-5) underwent this testing. Notably, each sample was conditioned before being placed in the muffle furnace. For Examples 4 and 5, the dense layer was facing the outside of the furnace cavity. In this respect, the dense layer was closer to the wall of the furnace cavity than the other gypsum core layer. It should be understood that the back of a gypsum panel sample is facing the muffle furnace wall, as opposed to the front of a gypsum panel sample that is facing the inner cavity of the muffle furnace.

### Example 1

A control gypsum panel was formed. The gypsum panel included a first facing material, a second facing material, and a gypsum core. The gypsum core of the control gypsum panel contained 60 #grade 5 vermiculite in an amount of about 5 wt. % by weight of the stucco utilized to form the gypsum slurry that formed said gypsum core. FIG. 1 illustrates the facing material at the back of the control gypsum panel sample. Notably, FIG. 1 illustrates a substantial amount of burnt facing material at the back of the control gypsum panel sample.

### Example 2

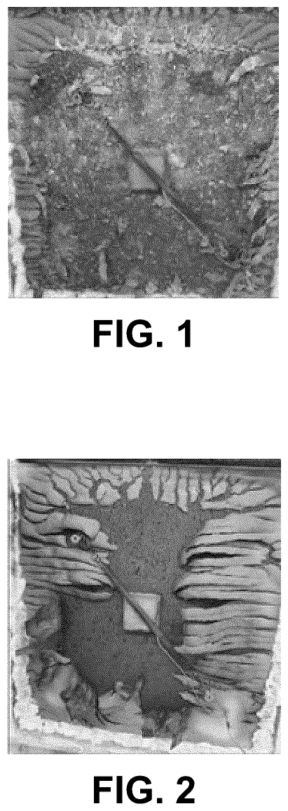

A gypsum panel was formed in accordance with the present disclosure. The gypsum panel included a first facing material, a second facing material, and a gypsum core. A fire resistance composition comprising phosphorus, nitrogen, and boron in a weight ratio of 52:43:5 was diluted with water to achieve a 15 wt. % solution and sprayed on the facing material at the back of the gypsum panel in an amount of about 0.16 wt. % by weight of the stucco utilized to form the gypsum slurry that formed the gypsum core. The fire resistance composition contained monoammonium phosphate, diammonium phosphate, and boric acid. The gypsum core of the gypsum panel contained 60 #grade 5 vermiculite in an amount of about 5 wt. % by weight of the stucco utilized to form the gypsum slurry that formed the gypsum core. FIG. 2 illustrates the facing material at the back of the gypsum panel sample. Notably, FIG. 2 illustrates a significant decrease in the amount of burnt facing material (i.e., an increase in the amount of unburnt facing material) at the back of the gypsum panel sample as compared to the control gypsum panel sample.

### Example 3

A gypsum panel was formed in accordance with the present disclosure. The gypsum panel included a first facing material, a second facing material, and a gypsum core. A fire resistance composition comprising phosphorus, nitrogen, and boron in a weight ratio of 85:6:8 was diluted with water to achieve a 10 wt. % solution and sprayed on the facing material at the back of the gypsum panel in an amount of about 0.12 wt. % by weight of the stucco utilized to form the gypsum slurry that formed the gypsum core. The fire resistance composition contained monoammonium phosphate, sodium trimetaphosphate, and boric acid. The gypsum core of the gypsum panel contained 60 #grade 5 vermiculite in an amount of about 5 wt. % by weight of the stucco utilized to form the gypsum slurry that formed the gypsum core. FIG. 3 illustrates the facing material at the back of the gypsum panel sample. Notably, FIG. 3 illustrates a significant decrease in the amount of burnt facing material (i.e., an increase in the amount of unburnt facing material) at the back of the gypsum panel sample as compared to the control gypsum panel sample.

### Example 4

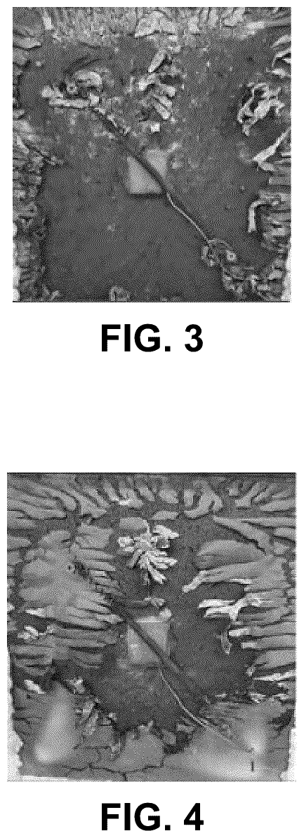

A gypsum panel was formed in accordance with the present disclosure. The gypsum panel included a first facing material, a second facing material, and a gypsum core. Notably, the gypsum panel of Example 4 included a dense layer. The dense layer contained a fire resistance composition comprising phosphorus and boron in a weight ratio of 93:7 in an amount of about 15 wt. % by weight of the stucco utilized to form the gypsum slurry that formed said dense layer. The fire resistance composition contained sodium trimetaphosphate and boric acid. The other gypsum core layer of the gypsum panel contained 2 wt. % Amsol condensed silica (30 Al % solution) by weight of the stucco utilized to form the gypsum slurry that formed said gypsum core layer. FIG. 4 illustrates the facing material at the back of the gypsum panel sample. Notably, FIG. 4 illustrates a significant decrease in the amount of burnt facing material (i.e., an increase in the amount of unburnt facing material) at the back of the gypsum panel sample as compared to the control gypsum panel sample.

### Example 5

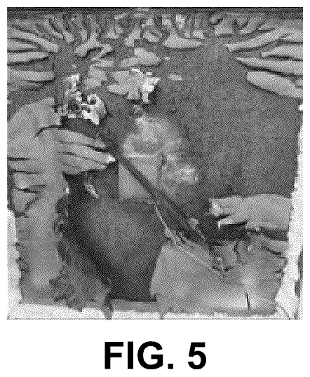

A gypsum panel was formed in accordance with the present disclosure. The gypsum panel included a first facing material, a second facing material, and a gypsum core. Notably, the gypsum panel of Example 5 included a dense layer. The dense layer contained a fire resistance composition comprising phosphorus and boron in a weight ratio of 93:7 in an amount of about 15 wt. % by weight of the stucco utilized to form the gypsum slurry that formed said dense layer. The fire resistance composition contained sodium trimetaphosphate and boric acid. The other gypsum core layer of the gypsum panel contained 60 #grade 5 vermiculite in an amount of about 5 wt. % by weight of the stucco utilized to form the gypsum slurry that formed said gypsum core layer. FIG. 5 illustrates the facing material at the back of the gypsum panel sample. Notably, FIG. 5 illustrates a significant decrease in the amount of burnt facing material (i.e., an increase in the amount of unburnt facing material) at the back of the gypsum panel sample as compared to the control gypsum panel sample.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum panel comprising:
a gypsum core, the gypsum core comprising gypsum;
a fire resistance composition, the fire resistance composition comprising a phosphorus containing additive, the fire resistance composition comprising nitrogen, boron, or a combination thereof, wherein the weight ratio of phosphorus to nitrogen in the fire resistance composition is 40-95:0-50, wherein the weight ratio of phosphorus to boron in the fire resistance composition is 40-95:0-10; and
a first facing material and a second facing material sandwiching the gypsum core.

2. The gypsum panel of claim 1, wherein the fire resistance composition comprises nitrogen.

3. The gypsum panel of claim 2, wherein the weight ratio of phosphorus to nitrogen in the fire resistance composition is 45-75:20-50.

4. The gypsum panel of claim 1, wherein the fire resistance composition comprises boron.

5. The gypsum panel of claim 4, wherein the weight ratio of phosphorus to boron in the fire resistance composition is 45-75:1-10.

6. The gypsum panel of claim 1, wherein the fire resistance composition comprises nitrogen and boron.

7. The gypsum panel of claim 6, wherein the weight ratio of nitrogen to boron in the fire resistance composition is 20-50:1-10.

8. The gypsum panel of claim 6, wherein the weight ratio of phosphorus, nitrogen, and boron in the fire resistance composition is 40-95:1-50:1-10.

9. The gypsum panel of claim 6, wherein the weight ratio of phosphorus, nitrogen, and boron in the fire resistance composition is 40-75:20-50:1-10.

10. The gypsum panel of claim 1, wherein the fire resistance composition is present in the gypsum core in an amount from about 0.001 wt. % to about 3 wt. %.

11. The gypsum panel of claim 1, wherein the fire resistance composition is present in the gypsum panel in an amount from about 0.001 lbs/MSF to about 50 lbs/MSF.

12. The gypsum panel of claim 1, wherein the gypsum core comprises a first gypsum core layer and a second gypsum core layer, the first gypsum core layer having a greater density than the second gypsum core layer, wherein the first gypsum core layer comprises the fire resistance composition.

13. The gypsum panel of claim 12, wherein the fire resistance composition is present in the first gypsum core layer in an amount from about 0.001 wt. % to about 3 wt. %.

14. The gypsum panel of claim 1, wherein the fire resistance composition is present on a surface of the first facing material, the second facing material, or both.

15. The gypsum panel of claim 14, wherein the fire resistance composition penetrates at least a portion of a thickness of the first facing material, the second facing material, or both.

16. The gypsum panel of claim 14, wherein the fire resistance composition is applied to the first facing material, the second facing material, or both offline.

17. The gypsum panel of claim 1, wherein the fire resistance composition further comprises fiber.

18. A gypsum panel comprising:
a gypsum core, the gypsum core comprising gypsum;
a fire resistance composition, the fire resistance composition comprising a phosphorus containing additive and a boron containing additive, wherein the weight ratio of phosphorus to boron in the fire resistance composition is 50-95:1-10; and
a first facing material and a second facing material sandwiching the gypsum core.

19. The gypsum panel of claim 18, wherein the weight ratio of phosphorus to boron in the fire resistance composition is 70-95:2-9.

20. The gypsum panel of claim 18, wherein the fire resistance composition is present in the gypsum core in an amount from about 0.001 wt. % to about 10 wt. %.

21. A method for making a gypsum panel comprising:
providing a first facing material;
depositing a gypsum slurry comprising stucco and water onto the first facing material;
providing a second facing material on the gypsum slurry;
allowing the stucco to convert to calcium sulfate dihydrate; and
wherein the gypsum panel comprises a fire resistance composition, the fire resistance composition comprising a phosphorus containing additive, the fire resistance composition comprising nitrogen, boron, or a combination thereof, wherein the weight ratio of phosphorus to nitrogen in the fire resistance composition is 40-95:0-50, wherein the weight ratio of phosphorus to boron in the fire resistance composition is 40-95:0-10.
